(19) United States
(12) Patent Application Publication
(10) Pub. No.: US 2025/0292181 A1
(43) Pub. Date: Sep. 18, 2025

(54) DUAL-LAYERED ARTIFICIAL INTELLIGENCE SYSTEM

(71) Applicant: BitHuman Inc, SAN FRANCISCO, CA (US)

(72) Inventors: Joseph P. Robinson, Salisbury, MA (US); Yun Fu, Newton, MA (US)

(73) Assignee: BitHuman Inc, SAN FRANCISCO, CA (US)

(21) Appl. No.: 18/604,504

(22) Filed: Mar. 14, 2024

(51) Int. Cl. G06Q 10/0639; G06N 3/006; G06Q 50/20

(52) U.S. Cl. CPC G06Q 10/06393; G06N 3/006; G06Q 50/205

(57) ABSTRACT

Embodiments of the present disclosure may include a dual-layered artificial intelligence system including a leading visual agent with a first large language model and other visual agents with customer-facing duties

### BACKGROUND OF THE INVENTION

Embodiments of the present disclosure may include a dual-layered artificial intelligence system and methods to include dual-layer artificial visual agents.

### BRIEF SUMMARY

Embodiments of the present disclosure may include a dual-layered artificial intelligence system including a leading visual agent with a first large language model. In some embodiments, the first large language model may be trained with datasets that include goal setting, progress tracking, ethical guidelines, brand voice, and regulatory compliance.

In some embodiments, the leading visual agent with the first large language model may be trained to be an expert for high-level tasks. In some embodiments, the leading visual agent may be only one visual agent that may be informed that the leading visual agent may be configured to guide other agents to a higher-level task within the dual-layered artificial intelligence system.

Embodiments may also include a set of customer-facing visual agents with a second large language model. In some embodiments, the second large language model may be trained with a second set of datasets that encompass general knowledge, specific domain ability, and user interaction protocols. In some embodiments, the set of customer-facing visual agents with the second large language model may be trained to interact directly with users, process natural language queries, and execute tasks.

In some embodiments, the leading visual agent may be configured to monitor the set of customer-facing visual agents. In some embodiments, the leading visual agent may be configured to ensure the set of customer-facing visual agents to adhere to a broader set of goals. In some embodiments, process of the monitoring and ensuring may be analogous to how a teacher may use a curriculum to keep a course on track.

In some embodiments, the process may be configured to serve as guardrails to ensure that outputs stay within predefined parameters. In some embodiments, the predefined parameters may include brand consistency, ethical considerations, and other overarching goals. In some embodiments, the set of customer-facing visual agents may be configured to have no knowledge that another visual agent may be guiding them.

In some embodiments, the set of customer-facing agents may be configured to communicate their interactions with users regularly to the leading visual agent. Embodiments may also include an artificial intelligence engine coupled to both the leading visual agent with a first large language model and the set of customer-facing visual agents with a second large language model.

In some embodiments, the artificial intelligence engine may be configured to adjust input datasets and parameters of the first large language model and the second large language model. In some embodiments, the artificial intelligence engine may be configured to convey instructions from the leading visual agent to the set of customer-facing visual agents. In some embodiments, the intelligence engine may be configured to realize Hierarchical Goal Management, Dynamic Feedback Loop for Real-time Course Correction, Ethical and Brand Guardrails, Adaptive Knowledge Transfer and Self-Optimizing System for Long-term Evolution.

Embodiments of the present disclosure may also include a method for providing services via a leading visual agent and a set of customer-facing virtual agents with artificial intelligence, the method including detecting, by one or more processors, a request from a first user. In some embodiments, the request could be a request to be educated with a specifically tailored class with a set of customer-facing virtual agents with artificial intelligence.

In some embodiments, a specifically tailored class may be configured to execute a specific plan for the user for the education. In some embodiments, the leading visual agent may be trained with datasets that include goal setting, progress tracking, ethical guidelines, brand voice, and regulatory compliance. In some embodiments, the leading visual agent with the first large language model may be trained to be an expert for high-level tasks.

In some embodiments, the leading visual agent may be only one visual agent that may be informed that the leading visual agent may be configured to guide other agents to a higher-level task. In some embodiments, the set of customer-facing visual agents with the second large language model may be trained to interact directly with users, process natural language queries, and execute tasks.

In some embodiments, the leading visual agent may be configured to monitor the set of customer-facing visual agents. In some embodiments, the leading visual agent may be configured to ensure the set of customer-facing visual agents to adhere to a broader set of goals. Embodiments may also include activating a first customer-facing visual agent of the set of customer-facing virtual agents with artificial intelligence.

In some embodiments, the first customer-facing visual agent may be picked by the leading visual agent with leading artificial intelligence. In some embodiments, the pick of the first customer-facing visual agent may be determined by the specifics and configurations of the first customer-facing visual agent and specific needs from the first user. In some embodiments, the first customer-facing visual agent may be configured to give educational service to the first user.

In some embodiments, the educational service may include teaching the first user, interacting with the first user, and answering questions from the first user. In some embodiments, the. In some embodiments, the set of visual agents may be configured to collaborate with each other. In some embodiments, the first customer-facing visual agent may be interacting with the leading visual agents.

In some embodiments, an artificial intelligence engine may be coupled to the one or more processors and a server and to the leading visual agent and the set of customer-facing visual agents. In some embodiments, the artificial intelligence engine may be trained by human experts in the field. In some embodiments, the set of customer-facing visual agents may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the set of virtual agents. In some embodiments, any of the set of customer-facing visual agents may be configured to be displayed with an appearance of a real human or a humanoid or a cartoon character. In some embodiments, any of the set of virtual agents' gender, age and ethnicity may be determined by the artificial Intelligence's analysis on input from the user.

In some embodiments, any of the set of customer-facing visual agents may be configured to be displayed in full-body or half-body portrait mode. In some embodiments, the artificial intelligence engine may be configured for real-time speech recognition, speech to text generation, real-time dialog generation, text-to-speech generation, voice-driven animation, and human avatar generation.

In some embodiments, the artificial intelligence engine may be configured to emulate different voices and use different languages. Embodiments may also include modifying education activities from the first customer-facing visual agent based on guidelines and input from the leading visual agent with communication between the first customer-facing visual agent and the leading visual agent. Embodiments may also include recording the modification and feedback from the first user. Embodiments may also include training other customer-facing visual agents of the set of customer-facing visual agents based on the recording.

Embodiments of the present disclosure may also include a method for providing services via a leading visual agent and a set of customer-facing virtual agents with artificial intelligence, the method including detecting, by one or more processors, a request from a first user. In some embodiments, the request could be a request to be educated with a specifically tailored class with a set of customer-facing virtual agents with artificial intelligence.

In some embodiments, a specifically tailored class may be configured to execute a specific plan for the first user for the education. In some embodiments, the leading visual agent may be trained with datasets that include goal setting, progress tracking, ethical guidelines, brand voice, and regulatory compliance. In some embodiments, the leading visual agent with the first large language model may be trained to be an expert for high-level tasks.

In some embodiments, the leading visual agent may be only one visual agent that may be informed that the leading visual agent may be configured to guide other agents to a higher-level task. In some embodiments, the set of customer-facing visual agents with the second large language model may be trained to interact directly with users, process natural language queries, and execute tasks.

In some embodiments, the leading visual agent may be configured to monitor the set of customer-facing visual agents. In some embodiments, the leading visual agent may be configured to ensure the set of customer-facing visual agents to adhere to a broader set of goals. Embodiments may also include activating a first customer-facing visual agent of the set of customer-facing virtual agents with artificial intelligence.

In some embodiments, the first customer-facing visual agent may be picked by the leading visual agent with leading artificial intelligence. In some embodiments, the pick of the first customer-facing visual agent may be determined by specifics and configurations of the first customer-facing visual agent and specific needs from the first user. In some embodiments, the first customer-facing visual agent may be configured to give educational service to the first user.

In some embodiments, the educational service may include teaching, interacting with the first user, answering questions from the first user. In some embodiments, the. In some embodiments, the set of visual agents may be configured to collaborate with each other. In some embodiments, the first customer-facing visual agent may be interacting with the leading visual agents.

In some embodiments, an artificial intelligence engine may be coupled to the one or more processors and a server and the leading visual agent and the set of customer-facing visual agents. In some embodiments, the artificial intelligence engine may be trained by human experts in the field. In some embodiments, the set of customer-facing visual agents may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the set of virtual agents. In some embodiments, any of the set of customer-facing visual agents may be configured to be displayed with an appearance of a real human or a humanoid or a cartoon character. In some embodiments, any of the set of virtual agents' gender, age and ethnicity may be determined by the artificial Intelligence's analysis on input from the user.

In some embodiments, any of the set of customer-facing visual agents may be configured to be displayed in full body or half body portrait mode. In some embodiments, the artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. Embodiments may also include modifying education activities from the first customer-facing visual agent based on guidelines and input from the leading visual agent with communication between the first customer-facing visual agent and the leading visual agent.

Embodiments may also include detecting, by one or more processors, a request from a second user. In some embodiments, the request could be a request to be educated with a specifically tailored class with a set of customer-facing virtual agents with artificial intelligence. In some embodiments, a specifically tailored class may be configured to execute a specific plan for the second user for the education.

Embodiments may also include activating a second customer-facing visual agent of the set of customer-facing virtual agents with artificial intelligence. In some embodiments, the second customer-facing visual agent may be picked by the leading visual agent with leading artificial intelligence. In some embodiments, the pick of the first customer-facing visual agent may be determined by specifics and configurations of the second customer-facing visual agent and specific needs from the second user.

In some embodiments, the second customer-facing visual agent may be configured to give educational service to the second user. In some embodiments, the educational service may include teaching, interacting with the second user, answering questions from the second user. In some embodiments, the. In some embodiments, the set of visual agents may be configured to collaborate with each other.

In some embodiments, the second customer-facing visual agent may be interacting with the leading visual agents. In some embodiments, the set of customer-facing visual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents.

In some embodiments, any of the set of customer-facing visual agents may be configured to be displayed with an appearance of a real human or a humanoid or a cartoon character. In some embodiments, any of the set of virtual agents' gender, age and ethnicity may be determined by the artificial Intelligence's analysis on input from the user. In some embodiments, any of the set of customer-facing visual agents may be configured to be displayed in full-body or half-body portrait mode.

In some embodiments, the artificial intelligence engine may be configured for real-time speech recognition, speech-to-text generation, real-time dialog generation, text-to-speech generation, voice-driven animation, and human avatar generation. In some embodiments, the artificial intelligence engine may be configured to emulate different voices and use different languages. Embodiments may also include modifying education activities from the second customer-facing visual agent based on guidelines and input from the leading visual agent with communication between the second customer-facing visual agent and the leading visual agent. Embodiments may also include recording the modification and feedback from the second user. Embodiments may also include training other customer-facing visual agents of the set of customer-facing visual agents based on the recording.

In some embodiments, the methods disclosed here comprise deploying an LLM as the “conductor,” with one or more LLMs making up the “orchestra.” The conductor is aware of the high-level task, while those in the orchestra are only concerned with the task. In this way, the conductor ensures that the orchestra stays aligned and true to the end goal, allowing it to do what they do best. In some embodiments, the conductor is initialized with the global knowledge of high-level goals, brand information, guardrails, etc., which is then divided into tasks that are used to initialize each agent in the orchestra. The task is not static but will adjust based on the last output of that respective agent. Prompts are updated each iteration to achieve the higher-level goal. At any point, if a member of the orchestra falls out of the expectation of the conductor, then the task could be updated to align that agent with the bigger picture better. In summary, we propose a dual-layered Large Language Model (LLM) system where one LLM acts as a guide or teacher (i.e., conductor), while the other(s) serve as the orchestra executing tasks. The conductor monitors and ensures that the orchestra adheres to a broader set of goals, analogous to how a teacher may use a curriculum to keep a course on track. This setup could serve as a guardrail to ensure that outputs stay within predefined parameters, whether for brand consistency, ethical considerations, or other overarching goals.

In some embodiments, the methods and system include the following elements:
Layered Large Language Models (LLMs): 1. User-Facing Agent(s) (Orchestra): One or more agents designed to interact directly with users, process natural language queries, and execute tasks. It is trained on a diverse dataset encompassing general knowledge, specific domain ability, and user interaction protocols. There is no need to have these LLMs know an LLM is guiding them. 2.Lead LLM (Conductor): The LLM operates as the supervisor. It does not interact with the user but checks the outputs and decisions of the primary LLM. It is trained on datasets that include goal setting, progress tracking, ethical guidelines, brand voice, and regulatory compliance. This LLM is the only one informed that it guides others to a higher-level task. In some embodiments, the methods and system disclosed here include these Novel and unusual features: 1. Hierarchical Goal Management: Existing LLMs typically work with a flat structure of goal orientation. The novel feature here introduces a hierarchy where the guiding LLM sets higher-level goals, akin to a manager or director, allowing for complex, multi-step tasks to be executed with better focus and alignment with the end goals. 2. Dynamic Feedback Loop for Real-time Course Correction: Instead of relying on post-process analysis, the guiding LLM provides the orchestra with real-time feedback and course corrections. This dynamic interaction mirrors a real-time, adaptive learning process more strongly associated with human mentorship than traditional static AI models. 3. Ethical and Brand Guardrails: The Guide-Itinerary LLM acts as an ethical and branding overseer, ensuring all user-facing interactions stay within a defined moral framework and brand voice. This differs substantially from existing models, where ethical and branding guidelines are typically hardcoded and need more flexibility in real-time adjustment. 4. Adaptive Knowledge Transfer: The guiding LLM (i.e., conductor) can adaptively transfer knowledge to the orchestra, enhancing its learning curve and enabling it to handle unexpected queries more effectively. This feature uses the “teaching” concept, where the guiding LLM recognizes gaps in the orchestra responses and fills those gaps, akin to a teacher identifying and addressing a student's learning needs. 5. Self-Optimizing System for Long-term Evolution: The Guide-Itinerary LLM pair can evolve to optimize their interaction and improve the system's overall performance over time. This continual self-optimization could lead to a more autonomous and efficient system, starkly contrasting existing systems that require external interventions for significant upgrades or changes.
In some embodiments, the methods and system disclosed here include these improvements: 1. Enhanced Efficiency in Complex Task Management: The invention allows for a more sophisticated execution of complex tasks that are typically beyond the scope of a singular LLM. By introducing a layered approach, the user-facing LLM can handle interconnected tasks while aligning with the overarching goal, significantly enhancing efficiency and task completion rates. 2. Real-time Adaptability to User Needs and Goals: The guiding LLM can dynamically adapt the user-facing LLM's approach based on real-time feedback, leading to a more personalized and goal-centric user experience. This adaptability is a leap forward from the more static nature of current LLMs, which often require manual retraining or fine-tuning to adjust to new goals or user feedback. 3. Cost-Effectiveness in Long-term Operation and Maintenance: Through the self-optimizing nature of the paired LLM system, there's a reduction in the need for frequent manual updates and interventions. This self-improvement leads to lower operational costs over time, as the system's maintenance becomes largely automated and more efficient at achieving its goals with less resource input. 4. Improved Compliance and Risk Management: The Guide-Itinerary LLM serves as a compliance monitor, constantly ensuring that the user-facing LLM's outputs adhere to regulatory, ethical, and brand-specific guidelines. This continual oversight can mitigate risks associated with non-compliance and unethical AI behavior, potentially saving organizations from costly legal and reputational damage. 5. Scalability Across Different Domains: The layered LLM structure is designed to be domain-agnostic, offering scalability across various industries. Whether in healthcare, finance, or customer service, the system can be adapted to specific domain needs, ensuring consistency and quality of service, which is often a challenge with current one-size-fits-all LLM solutions.
In some embodiments, potential uses for these methods and systems are as follows: The dual-layer LLM system introduces the potential for creating more sophisticated, purposeful AI tools that can adapt over time, offering significant benefits in personalization, strategic alignment, and ethical governance. 1.Personalized Education Platforms: The conductor LLM could act as a personalized curriculum designer for educational content, ensuring the orchestra adapts to individual student learning styles and progress, and supplying customized educational pathways and resources. 2. Advanced Healthcare Advisory Systems: In healthcare, such a system could track patient treatment plans. The guide LLM would ensure the orchestra provides advice and follow-up that align with long-term treatment goals, considering the patient's evolving medical history and condition. Hence, diagnostic agents that understand both patient history and in-depth medical knowledge. 3. Strategic Business Planning Assistants: For businesses, this invention could serve as a strategic planning assistant, with the guiding LLM ensuring that the orchestra stays aligned with broader business goals, market trends, and operational KPIs when supplying tactical suggestions or performing market analyses. 4. Interactive Customer Service for Complex Products: The invention could be used in customer service to help users with complex products like electronics or machinery. The guiding LLM would ensure the orchestra provides support that resolves immediate issues and aligns with a customer's usage patterns and product lifecycle. 5.AI Ethics and Compliance Monitoring: The Guide-Itinerary LLM could oversee other AI systems to ensure ethical AI behavior and compliance with industry regulations, particularly in sectors like finance or law, where strict guidelines are paramount. Hence, A shared Agent for others (i.e., Agent(s) of interest) to confirm their output continually follows priority settings. 6. Retail: Intelligent customer service agents capable of long-term relationship management and detailed product explanations. 7. Smart Homes: Agents that can manage long-term energy-saving goals and intricate control of home appliances.

### BRIEF DESCRIPTION OF THE FIGURES

FIG. 1 is a block diagram illustrating a dual-layered artificial intelligence system, according to some embodiments of the present disclosure.

FIG. 2 is a flowchart illustrating a method for providing services, according to some embodiments of the present disclosure.

FIG. 3A is a flowchart illustrating a method for providing services, according to some embodiments of the present disclosure.

FIG. 3B is a flowchart extending from FIG. 3A and further illustrating the method for providing services, according to some embodiments of the present disclosure.

FIG. 4 is a diagram showing an example of a method for providing services via a dual-layer artificial intelligence system, according to some embodiments of the present disclosure.

FIG. 5 is a diagram showing a second example of a method for providing services via a dual-layer artificial intelligence system, according to some embodiments of the present disclosure.

FIG. 6 is a diagram showing a third example of a method for providing services via a dual-layer artificial intelligence system, according to some embodiments of the present disclosure.

FIG. 7 is a diagram showing a fourth example of a method for providing services via a dual-layer artificial intelligence system, according to some embodiments of the present disclosure.

FIG. 8 is a diagram showing a fifth example of a method for providing services via a dual-layer artificial intelligence system, according to some embodiments of the present disclosure.

FIG. 9 is a diagram showing a sixth example of a method for providing services via a dual-layer artificial intelligence system, according to some embodiments of the present disclosure.

FIG. 10 is a diagram showing a seventh example of a method for providing services via a dual-layer artificial intelligence system, according to some embodiments of the present disclosure.

### DETAILED DESCRIPTION

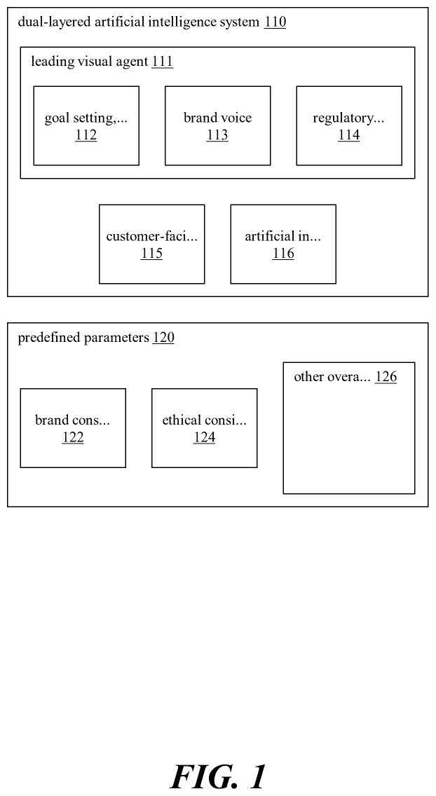

FIG. 1 is a block diagram that describes a dual-layered artificial intelligence system 110, according to some embodiments of the present disclosure. In some embodiments, the dual-layered artificial intelligence system 110 may include a leading visual agent 111 with a first large language model, a set of customer-facing visual agents 115 with a second large language model, and an artificial intelligence engine 116 coupled to both the leading visual agent with a first large language model and the set of customer-facing visual agents 115 with a second large language model.

In some embodiments, the leading visual agent 111 may include brand voice 113 and regulatory compliance 114. The leading visual agent 111 may also include goal setting, progress tracking, ethical guidelines 112. The first large language model may be trained with datasets that. The leading visual agent 111 with the first large language model may be trained to be an expert for high-level tasks. The leading visual agent 111 may be only one visual agent that may be informed that the leading visual agent 111 may be configured to guide other agents to a higher-level task within the dual-layered artificial intelligence system 110.

In some embodiments, the second large language model may be trained with a second set of datasets that encompass general knowledge, specific domain ability, and user interaction protocols. The set of customer-facing visual agents 115 with the second large language model may be trained to interact directly with users, process natural language queries, and execute tasks. The leading visual agent 111 may be configured to monitor the set of customer-facing visual agents 115.

In some embodiments, the leading visual agent 111 may be configured to ensure the set of customer-facing visual agents 115 to adhere to a broader set of goals. Process of the monitoring and ensuring may be analogous to how a teacher may use a curriculum to keep a course on track. The process may be configured to serve as guardrails to ensure that outputs may stay within predefined parameters 120. The artificial intelligence engine 116 may be configured to adjust input datasets and parameters of the first large language model and the second large language model.

In some embodiments, the artificial intelligence engine 116 may be configured to convey instructions from the leading visual agent to the set of customer-facing visual agents 115. The intelligence engine 116 may be configured to realize Hierarchical Goal Management, a Dynamic Feedback Loop for Real-time Course Correction, Ethical and Brand Guardrails, Adaptive Knowledge Transfer, and Self-Optimizing System for Long-term Evolution.

In some embodiments, the predefined parameters 120 may include brand consistency 122, ethical considerations 124, and other overarching goals 126. In some embodiments, the set of customer-facing visual agents 115 has no knowledge that another visual agent may be guiding them. The set of customer-facing agents 115 may be configured to communicate their interactions with users regularly to the leading visual agent 111.

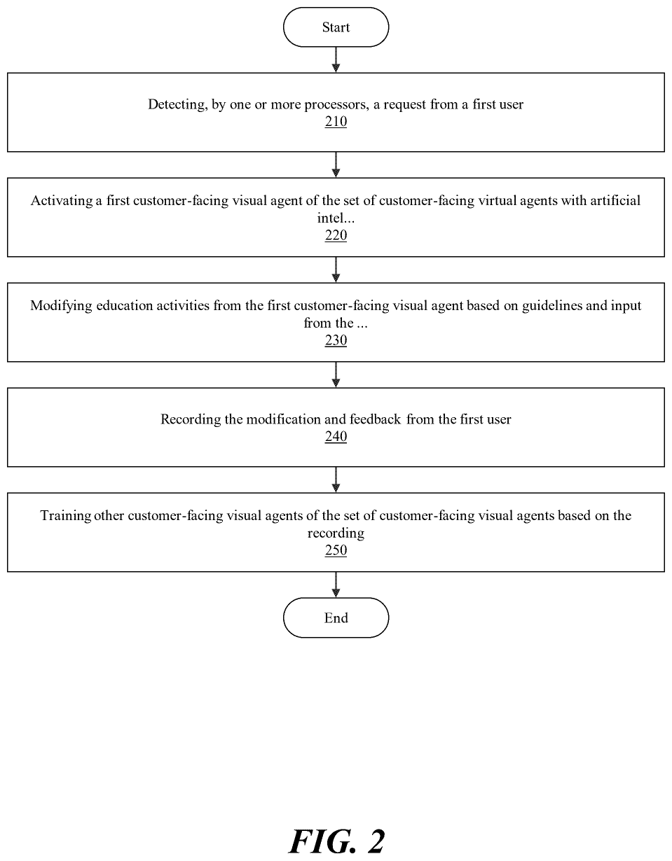

FIG. 2 is a flowchart that describes a method for providing services, according to some embodiments of the present disclosure. In some embodiments, at 210, the method may include detecting, by one or more processors, a request from a first user. At 220, the method may include activating a first customer-facing visual agent of the set of customer-facing virtual agents with artificial intelligence. At 230, the method may include modifying education activities from the first customer-facing visual agent based on guidelines and input from the leading visual agent with communication between the first customer-facing visual agent and the leading visual agent. At 240, the method may include recording the modification and feedback from the first user. At 250, the method may include training other customer-facing visual agents of the set of customer-facing visual agents based on the recording.

In some embodiments, the request could be a request to be educated with a specifically tailored class with a set of customer-facing virtual agents with artificial intelligence. A specifically tailored class may be configured to execute a specific plan for the user for the education. The leading visual agent may be trained with datasets that include goal setting, progress tracking, ethical guidelines, brand voice, and regulatory compliance.

In some embodiments, the leading visual agent with the first large language model may be trained to be an expert for high-level tasks. The leading visual agent may be only one visual agent who may be informed that the leading visual agent may be configured to guide other agents to a higher-level task. The set of customer-facing visual agents with the second large language model may be trained to interact directly with users, process natural language queries, and execute tasks.

In some embodiments, the leading visual agent may be configured to monitor the set of customer-facing visual agents. The leading visual agent may be configured to ensure the set of customer-facing visual agents to adhere to a broader set of goals. The first customer-facing visual agent may be picked by the leading visual agent with leading artificial intelligence. The pick of the first customer-facing visual agent may be determined by specifics and configurations of the first customer-facing visual agent and specific needs from the first user.

In some embodiments, the first customer-facing visual agent may be configured to give educational service to the first user. The educational service comprises teaching the first user, interacting with the first user, answering questions from the first user. The. The set of visual agents may be configured to collaborate with each other. The first customer-facing visual agent may be interacting with the leading visual agents.

In some embodiments, an artificial intelligence engine may be coupled to the one or more processors and a server and to the leading visual agent and the set of customer-facing visual agents. The artificial intelligence engine may be trained by human experts in the field. The set of customer-facing visual agents may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the set of virtual agents. Any of the set of customer-facing visual agents may be configured to be displayed with an appearance of a real human or a humanoid or a cartoon character. Any of the set of virtual agents' gender, age and ethnicity may be determined by the artificial Intelligence's analysis on input from the user.

In some embodiments, any of the set of customer-facing visual agents may be configured to be displayed in full-body or half-body portrait mode. The artificial intelligence engine may be configured for real-time speech recognition, speech-to-text generation, real-time dialog generation, text-to-speech generation, voice-driven animation, and human avatar generation. The artificial intelligence engine may be configured to emulate different voices and use different languages.

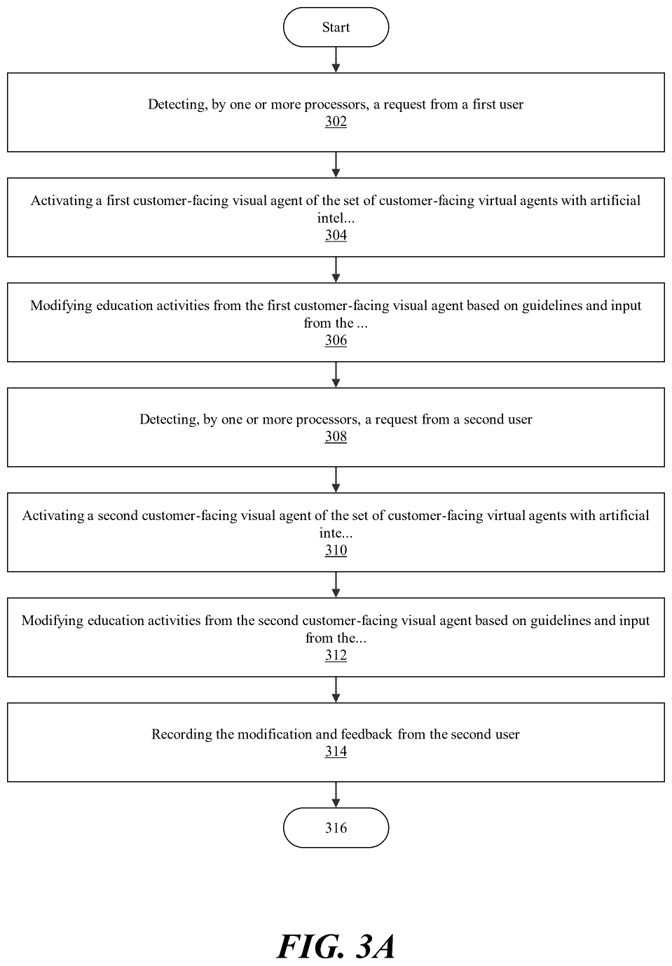

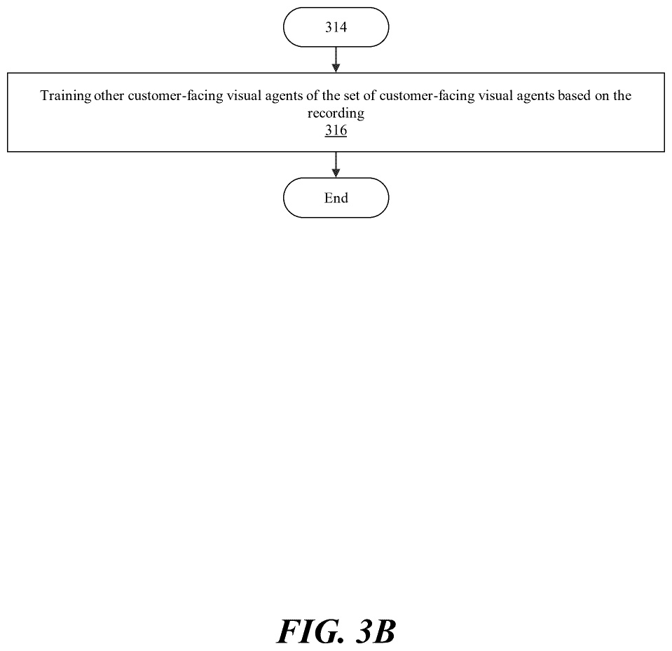

FIGS. 3A to 3B are flowcharts that describe a method for providing services, according to some embodiments of the present disclosure. In some embodiments, at 302, the method may include detecting, by one or more processors, a request from a first user. At 304, the method may include activating a first customer-facing visual agent of the set of customer-facing virtual agents with artificial intelligence. At 306, the method may include modifying education activities from the first customer-facing visual agent based on guidelines and input from the leading visual agent with communication between the first customer-facing visual agent and the leading visual agent.

In some embodiments, at 308, the method may include detecting, by one or more processors, a request from a second user. At 310, the method may include activating a second customer-facing visual agent of the set of customer-facing virtual agents with artificial intelligence. At 312, the method may include modifying education activities from the second customer-facing visual agent based on guidelines and input from the leading visual agent with communication between the second customer-facing visual agent and the leading visual agent. At 314, the method may include recording the modification and feedback from the second user. At 316, the method may include training other customer-facing visual agents of the set of customer-facing visual agents based on the recording.

In some embodiments, the request could be a request to be educated with a specifically tailored class with a set of customer-facing virtual agents with artificial intelligence. A specifically tailored class may be configured to execute a specific plan for the first user for the education. The leading visual agent may be trained with datasets that include goal setting, progress tracking, ethical guidelines, brand voice, and regulatory compliance.

In some embodiments, the leading visual agent with the first large language model may be trained to be an expert for high-level tasks. The leading visual agent may be only one visual agent that may be informed that the leading visual agent may be configured to guide other agents to a higher-level task. The set of customer-facing visual agents with the second large language model may be trained to interact directly with users, process natural language queries, and execute tasks.

In some embodiments, the leading visual agent may be configured to monitor the set of customer-facing visual agents. The leading visual agent may be configured to ensure the set of customer-facing visual agents to adhere to a broader set of goals. The first customer-facing visual agent may be picked by the leading visual agent with leading artificial intelligence. The pick of the first customer-facing visual agent may be determined by specifics and configurations of the first customer-facing visual agent and specific needs from the first user.

In some embodiments, the first customer-facing visual agent may be configured to give educational service to the first user. The educational service comprises teaching, interacting with the first user, answering questions from the first user. The. The set of visual agents may be configured to collaborate with each other. The first customer-facing visual agent may be interacting with the leading visual agents. An artificial intelligence engine may be coupled to the one or more processors and a server and the leading visual agent and the set of customer-facing visual agents.

In some embodiments, the artificial intelligence engine may be trained by human experts in the field. The set of customer-facing visual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents. Any of the set of customer-facing visual agents may be configured to be displayed with an appearance of a real human or a humanoid or a cartoon character.

In some embodiments, any of the set of virtual agents' gender, age and ethnicity may be determined by the artificial Intelligence's analysis on input from the user. Any of the set of customer-facing visual agents may be configured to be displayed in full-body or half-body portrait mode. The artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. The request could be a request to be educated with a specifically tailored class with a set of customer-facing virtual agents with artificial intelligence. A specifically tailored class may be configured to execute a specific plan for the second user for the education. The second customer-facing visual agent may be picked by the leading visual agent with leading artificial intelligence.

In some embodiments, the pick of the first customer-facing visual agent may be determined by specifics and configurations of the second customer-facing visual agent and specific needs from the second user. The second customer-facing visual agent may be configured to give educational service to the second user. The educational service comprises teaching, interacting with the second user, and answering questions from the second user.

In some embodiments, The. The set of visual agents may be configured to collaborate with each other. The second customer-facing visual agent may be interacting with the leading visual agents. The set of customer-facing visual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents.

In some embodiments, any of the set of customer-facing visual agents may be configured to be displayed with an appearance of a real human or a humanoid or a cartoon character. Any of the set of virtual agents' gender, age and ethnicity may be determined by the artificial Intelligence's analysis on input from the user. Any of the set of customer-facing visual agents may be configured to be displayed in full-body or half-body portrait mode. The artificial intelligence engine may be configured for real-time speech recognition, speech to text generation, real-time dialog generation, text to speech generation, voice-driven animation, and human avatar generation. The artificial intelligence engine may be configured to emulate different voices and use different languages.

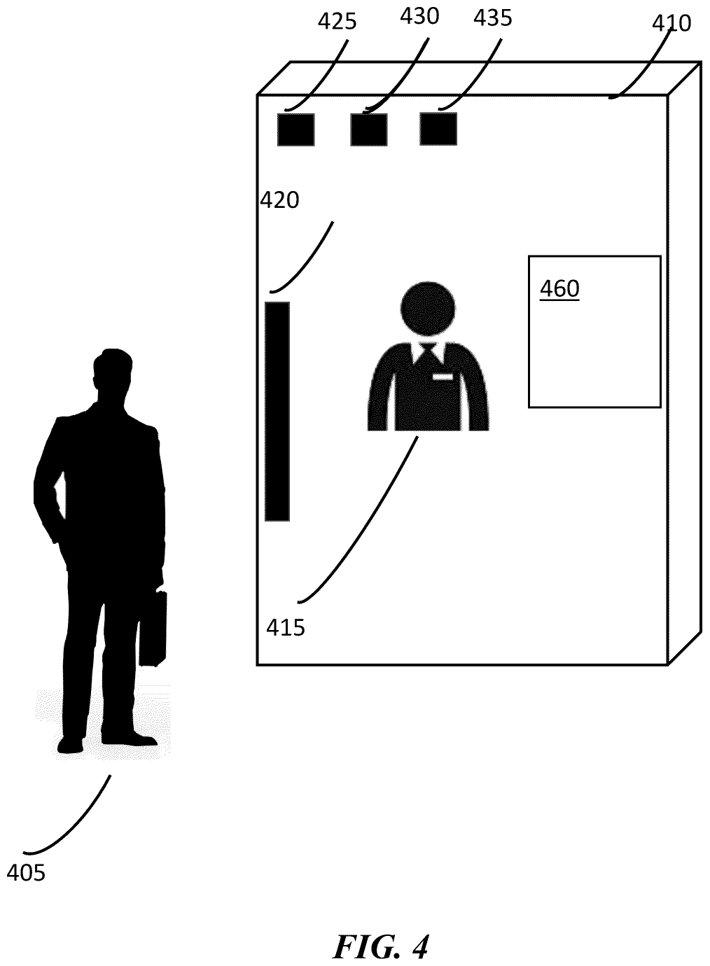

FIG. 4 is a diagram showing an example that describes the first example of a method for providing services via a dual-layer artificial intelligence system, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant with customer-facing duty 415 is active on the smart display 410. In some embodiments, a leading visual agent is guiding the artificial intelligence visual assistant with customer-facing duty 415 without the knowledge of the artificial intelligence visual assistant with customer-facing duty 415. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual agents as described in this example and the system and methods described in FIG. 1-3.

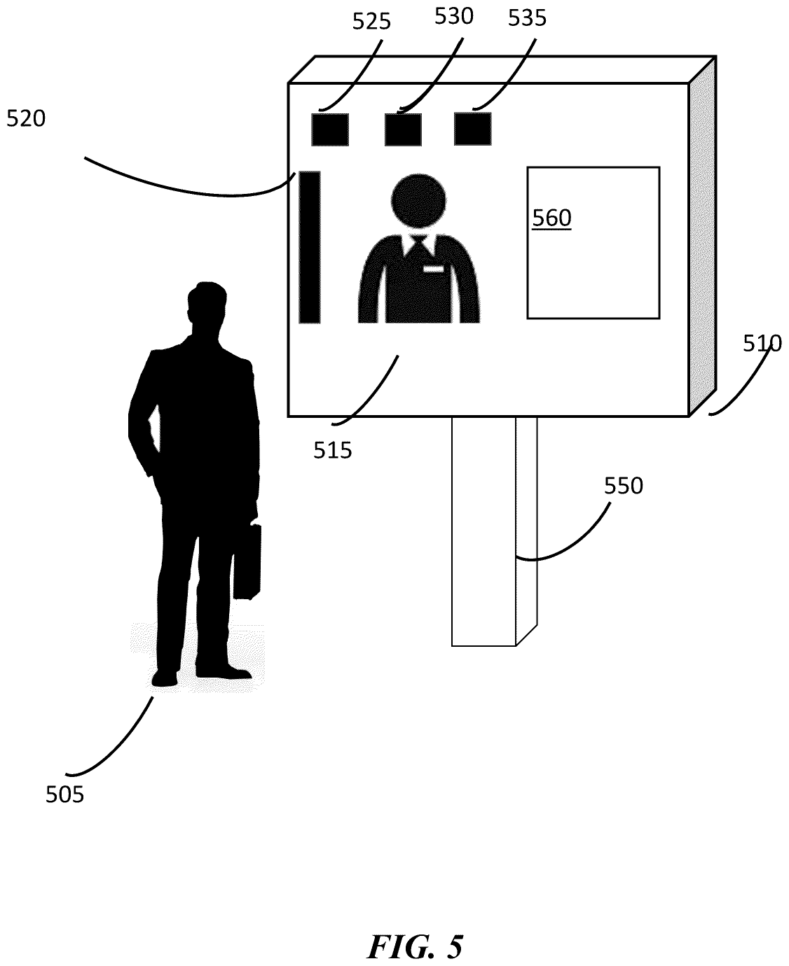

FIG. 5 is a diagram showing a second example of a method for providing services via a dual-layer artificial intelligence system, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant with customer-facing duty 515 is active on the smart display 510. In some embodiments, a leading visual agent is guiding the artificial intelligence visual assistant with customer-facing duty 515 without the knowledge of the artificial intelligence visual assistant with customer-facing duty 515. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user can interact with multiple AI visual assistants as described in this example and the system and methods described in FIG. 1-3.

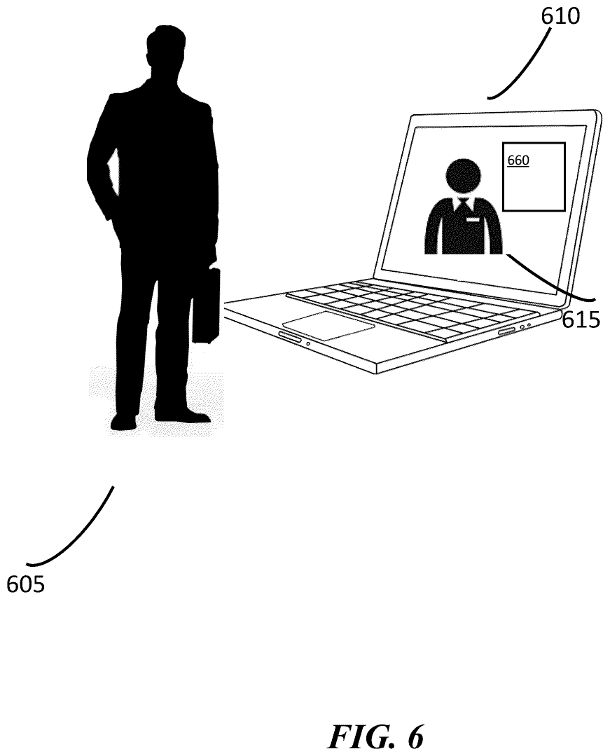

FIG. 6 is a diagram showing a third example of a method for providing services via a dual-layer artificial intelligence system, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 with customer-facing duty is active on the smart display 610. In some embodiments, a leading visual agent is guiding the artificial intelligence visual assistant with customer-facing duty 615 without the knowledge of the artificial intelligence visual assistant with customer-facing duty 615. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

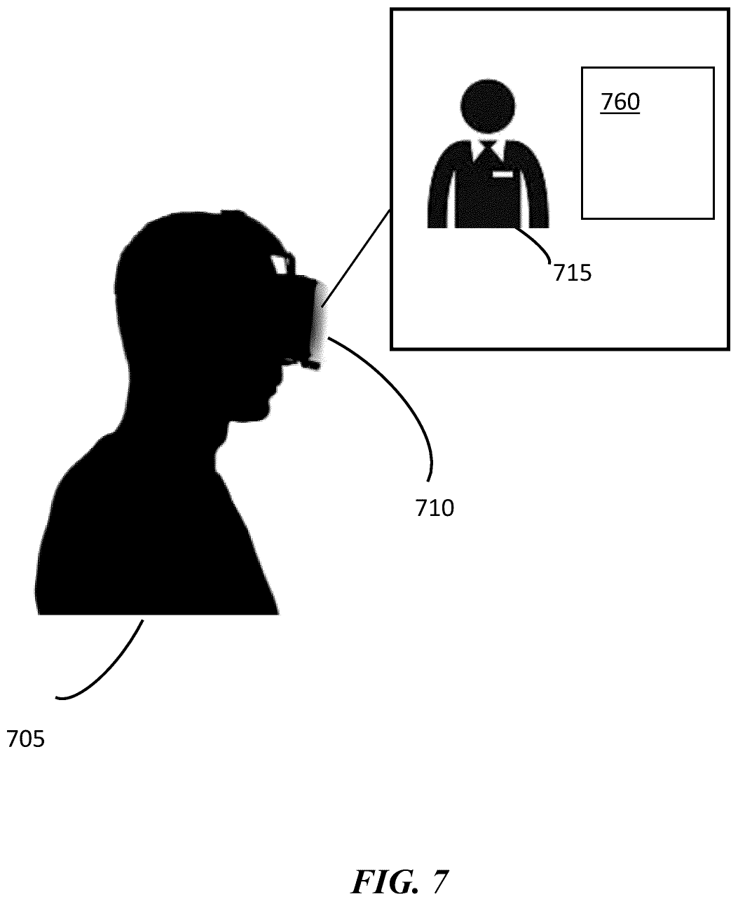

FIG. 7 is a diagram showing a fourth example of a method for providing services via a dual-layer artificial intelligence system, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 with customer-facing duty is active on the VR or AR device 710. In some embodiments, a leading visual agent is guiding the AI visual assistant with customer-facing duty 715 without the knowledge of the AI visual assistant with customer-facing duty 715. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service described in this paragraph. In some embodiments, other users can use this service described in this paragraph. In some embodiments, the user is able to interact with multiple AI visual assistants as described in this example and the system and methods described in FIG. 1-3.

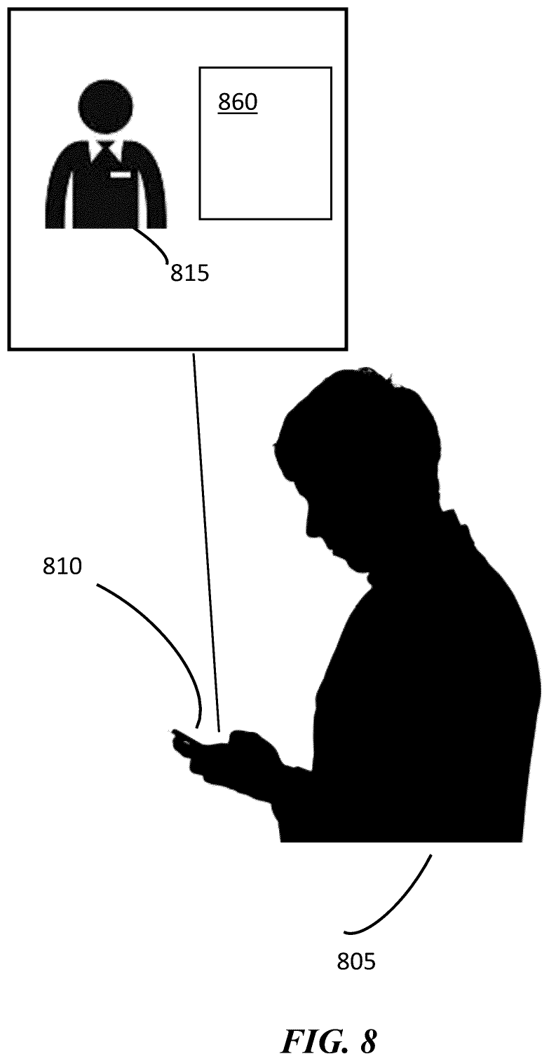

FIG. 8 is a diagram showing a fifth example of a method for providing services via a dual-layer artificial intelligence system, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 with customer-facing duty is active on the smartphone device 810. In some embodiments, a leading visual agent is guiding the AI visual assistant with customer-facing duty 815 without the knowledge of the AI visual assistant with customer-facing duty 815. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

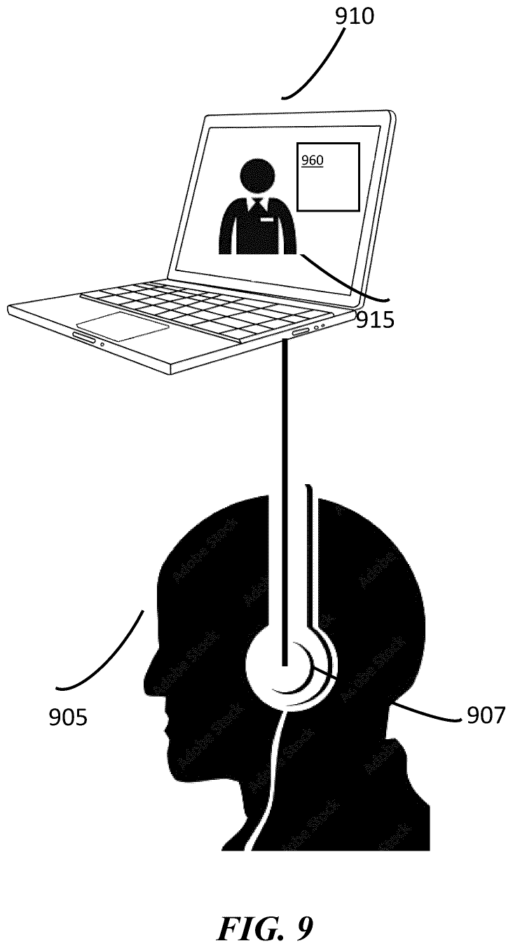

FIG. 9 is a diagram showing a sixth example of a method for providing services via a dual-layer artificial intelligence system, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 with customer-facing duty is active on the computer 910. In some embodiments, a leading visual agent is guiding the AI visual assistant with customer-facing duty 915 without the knowledge of the AI visual assistant with customer-facing duty 915. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

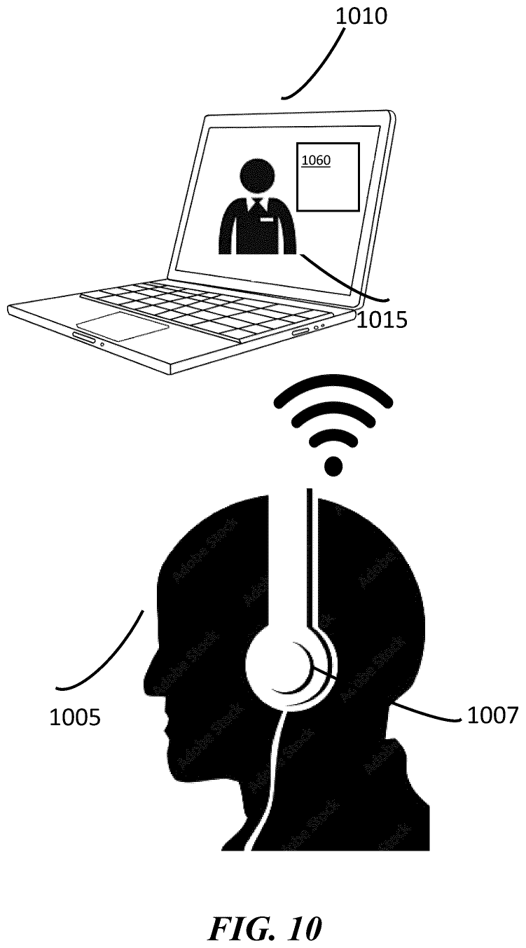

FIG. 10 is a diagram showing a seventh example of a method for providing services via a dual-layer artificial intelligence system, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 with customer-facing duty is active on the computer 1010. In some embodiments, a leading visual agent is guiding the AI visual assistant with customer-facing duty 1015 without the knowledge of the AI visual assistant with customer-facing duty 1015. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

1. A dual-layered artificial intelligence system comprising:
A leading visual agent with a first large language model, wherein the first large language model is trained with datasets that include goal setting, progress tracking, ethical guidelines, brand voice, and regulatory compliance, wherein the leading visual agent with the first large language model is trained to be an expert for high-level tasks, wherein the leading visual agent is only one visual agent that is informed that the leading visual agent is configured to guide other agents to a higher-level task within the dual-layered artificial intelligence system;
a set of customer-facing visual agents with a second large language model, wherein the second large language model is trained with a second set of datasets that encompass general knowledge, specific domain ability, and user interaction protocols, wherein the set of customer-facing visual agents with the second large language model are trained to interact directly with users, process natural language queries, and execute tasks, wherein the leading visual agent is configured to monitor the set of customer-facing visual agents, wherein the leading visual agent is configured to ensure the set of customer-facing visual agents to adhere to a broader set of goals, wherein process of the monitoring and ensuring is analogous to how a teacher may use a curriculum to keep a course on track, wherein the process is configured to serve as guardrails to ensure that outputs stay within predefined parameters, wherein the predefined parameters comprise brand consistency, ethical considerations, and other overarching goals, wherein the set of customer-facing visual agents is configured to have no knowledge that another visual agent is guiding them, wherein the set of customer-facing agents are configured to communicate their interactions with users regularly to the leading visual agent; and
an artificial intelligence engine coupled to both the leading visual agent with a first large language model and the set of customer-facing visual agents with a second large language model, wherein the artificial intelligence engine is configured to adjust input datasets and parameters of the first large language model and the second large language model, wherein the artificial intelligence engine is configured to convey instructions from the leading visual agent to the set of customer-facing visual agents, wherein the intelligence engine is configured to realize Hierarchical Goal Management, Dynamic Feedback Loop for Real-time Course Correction, Ethical and Brand Guardrails, Adaptive Knowledge Transfer and Self-Optimizing System for Long-term Evolution.

2. A method for providing services via a leading visual agent and a set of customer-facing virtual agents with artificial intelligence, the method comprising:
detecting, by one or more processors, a request from a first user, wherein the request could be a request to be educated with a specifically tailored class with a set of customer-facing virtual agents with artificial intelligence, wherein a specifically tailored class is configured to execute a specific plan for the user for the education, wherein the leading visual agent is trained with datasets that include goal setting, progress tracking, ethical guidelines, brand voice, and regulatory compliance, wherein the leading visual agent with the first large language model is trained to be an expert for high-level tasks, wherein the leading visual agent is only one visual agent that is informed that the leading visual agent is configured to guide other agents to a higher-level task, wherein the set of customer-facing visual agents with the second large language model are trained to interact directly with users, process natural language queries, and execute tasks, wherein the leading visual agent is configured to monitor the set of customer-facing visual agents, wherein the leading visual agent is configured to ensure the set of customer-facing visual agents to adhere to a broader set of goals;
activating a first customer-facing visual agent of the set of customer-facing virtual agents with artificial intelligence, wherein the first customer-facing visual agent is picked by the leading visual agent with leading artificial intelligence, wherein the pick of the first customer-facing visual agent is determined by specifics and configurations of the first customer-facing visual agent and specific needs from the first user, wherein the first customer-facing visual agent is configured to give educational service to the first user, wherein the educational service comprises teaching the first user, interacting with the first user, answering questions from the first user, wherein the wherein the set of visual agents are configured to collaborate with each other, wherein the first customer-facing visual agent is interacting with the leading visual agents, wherein an artificial intelligence engine is coupled to the one or more processors and a server and to the leading visual agent and the set of customer-facing visual agents, wherein the artificial intelligence engine is trained by human experts in the field, wherein the set of customer-facing visual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of customer-facing visual agents are configured to be displayed with an appearance of a real human or a humanoid or a cartoon character, wherein any of the set of virtual agents' gender, age and ethnicity is determined by the artificial Intelligence's analysis on input from the user, wherein any of the set of customer-facing visual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the first customer-facing visual agent based on guidelines and input from the leading visual agent with communication between the first customer-facing visual agent and the leading visual agent;
recording the modification and feedback from the first user; and
training other customer-facing visual agents of the set of customer-facing visual agents based on the recording.

3. A method for providing services via a leading visual agent and a set of customer-facing virtual agents with artificial intelligence, the method comprising:
detecting, by one or more processors, a request from a first user, wherein the request could be a request to be educated with a specifically tailored class with a set of customer-facing virtual agents with artificial intelligence, wherein a specifically tailored class is configured to execute a specific plan for the first user for the education, wherein the leading visual agent is trained with datasets that include goal setting, progress tracking, ethical guidelines, brand voice, and regulatory compliance, wherein the leading visual agent with the first large language model is trained to be an expert for high-level tasks, wherein the leading visual agent is only one visual agent that is informed that the leading visual agent is configured to guide other agents to a higher-level task, wherein the set of customer-facing visual agents with the second large language model are trained to interact directly with users, process natural language queries, and execute tasks, wherein the leading visual agent is configured to monitor the set of customer-facing visual agents, wherein the leading visual agent is configured to ensure the set of customer-facing visual agents to adhere to a broader set of goals;
activating a first customer-facing visual agent of the set of customer-facing virtual agents with artificial intelligence, wherein the first customer-facing visual agent is picked by the leading visual agent with leading artificial intelligence, wherein the pick of the first customer-facing visual agent is determined by specifics and configurations of the first customer-facing visual agent and specific needs from the first user, wherein the first customer-facing visual agent is configured to give educational service to the first user, wherein the educational service comprises teaching, interacting with the first user, answering questions from the first user, wherein the wherein the set of visual agents are configured to collaborate with each other, wherein the first customer-facing visual agent is interacting with the leading visual agents, wherein an artificial intelligence engine is coupled to the one or more processors and a server and the leading visual agent and the set of customer-facing visual agents, wherein the artificial intelligence engine is trained by human experts in the field, wherein the set of customer-facing visual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of customer-facing visual agents are configured to be displayed with an appearance of a real human or a humanoid or a cartoon character, wherein any of the set of virtual agents' gender, age and ethnicity is determined by the artificial Intelligence's analysis on input from the user, wherein any of the set of customer-facing visual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the first customer-facing visual agent based on guidelines and input from the leading visual agent with communication between the first customer-facing visual agent and the leading visual agent;
detecting, by one or more processors, a request from a second user, wherein the request could be a request to be educated with a specifically tailored class with a set of customer-facing virtual agents with artificial intelligence, wherein a specifically tailored class is configured to execute a specific plan for the second user for the education activating a second customer-facing visual agent of the set of customer-facing virtual agents with artificial intelligence, wherein the second customer-facing visual agent is picked by the leading visual agent with leading artificial intelligence, wherein the pick of the first customer-facing visual agent is determined by specifics and configurations of the second customer-facing visual agent and specific needs from the second user, wherein the second customer-facing visual agent is configured to give educational service to the second user, wherein the educational service comprises teaching, interacting with the second user, answering questions from the second user, wherein the wherein the set of visual agents are configured to collaborate with each other, wherein the second customer-facing visual agent is interacting with the leading visual agents, wherein the set of customer-facing visual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of customer-facing visual agents are configured to be displayed with an appearance of a real human or a humanoid or a cartoon character, wherein any of the set of virtual agents' gender, age and ethnicity is determined by the artificial Intelligence's analysis on input from the user, wherein any of the set of customer-facing visual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
modifying education activities from the second customer-facing visual agent based on guidelines and input from the leading visual agent with communication between the second customer-facing visual agent and the leading visual agent;
recording the modification and feedback from the second user; and
training other customer-facing visual agents of the set of customer-facing visual agents based on the recording.
